(19) United States
(12) Patent Application Publication
(10) Pub. No.: US 2026/0176198 A1
(43) Pub. Date: Jun. 25, 2026

(54) SLAG-BASED FINE AGGREGATE, SUPPLEMENTARY CEMENTITIOUS MATERIAL AND ULTRAHIGH-PERFORMANCE CONCRETE AS WELL AS PREPARATION METHODS AND USE THEREOF

(71) Applicant: SHANDONG UNIVERSITY, Jinan (CN)

(72) Inventors: Fengling ZHANG, Jinan (CN); Jinghang ZHANG, Jinan (CN); Kai PANG, Jinan (CN); Jinglong LI, Jinan (CN); Chenxu YAN, Jinan (CN); Xiufang ZHENG, Jinan (CN); Tongchun SU, Jinan (CN); Xiaoyu LI, Jinan (CN); Yupeng CUI, Jinan (CN); Xiangyu MENG, Jinan (CN); Min TANG, Jinan (CN)

(21) Appl. No.: 19/405,747

(22) Filed: Dec. 2, 2025

(30) Foreign Application Priority Data
Dec. 25, 2024 (CN) 2024119212922

(51) Int. Cl. C04B 18/06; C04B 7/14; C04B 7/43; C04B 7/52; C04B 20/02; C04B 20/04; C04B 28/08; C04B 40/00; C04B 40/02

(52) U.S. Cl. CPC C04B 18/067; C04B 7/14; C04B 7/434; C04B 7/52; C04B 20/0232; C04B 20/026; C04B 20/04; C04B 28/08; C04B 40/0046; C04B 40/0231

(57) ABSTRACT

The present invention relates to a slag-based fine aggregate, a supplementary cementitious material and UHPC as well as preparation methods and use thereof, and belongs to the technical field of building materials. The slag-based fine aggregate includes the following components: slag, nano-alumina, and a carbonization reaction amount of carbon dioxide. The slag-based UHPC includes the following components: cement, fly ash, silica fume, a slag-based supplementary cementitious material, the above-mentioned slag-based fine aggregate, natural river sand, a fiber, a water reducer, and water; and raw materials for preparing the slag-based supplementary cementitious material include slag and carbon dioxide. Through deep treatment of tunnel slag using a comprehensive optimization scheme, physical and chemical properties of the slag are enhanced, performance stability of a material is improved, and waste slag is successfully converted into a raw material for the UHPC.

### CROSS-REFERENCE TO RELATED APPLICATIONS

The present invention claims priority to Chinese Patent Application No. 202411921292.2, filed to China National Intellectual Property Administration on Dec. 25, 2024, entitled “SLAG-BASED FINE AGGREGATE, SUPPLEMENTARY CEMENTITIOUS MATERIAL AND ULTRAHIGH-PERFORMANCE CONCRETE AS WELL AS PREPARATION METHODS AND USE THEREOF”, the entire contents of which are incorporated into the present invention by reference and constitute a part of the present invention for all purposes.

### TECHNICAL FIELD

The present invention belongs to the technical field of building materials, and specifically relates to a slag-based fine aggregate, a supplementary cementitious material and ultrahigh-performance concrete as well as preparation methods and use thereof.

### BACKGROUND

Information disclosed in the background section is merely intended to increase understanding of the general background of the present invention, and is not necessarily taken as an acknowledgment or implication in any form that the information constitutes the prior art that has already become known to those of ordinary skill in the art.

Ultrahigh-performance concrete (UHPC) is a building material with excellent mechanical properties and durability, and has been widely used in high-demand structures such as bridges and high-rise buildings. However, the UHPC has a higher production cost, and especially due to the increased demands for high-performance aggregate and supplementary cementitious materials, carbon emission and resource consumption during production of the UHPC are increased.

During excavation of underground projects such as tunnels and chambers, a large amount of tunnel slag (hereinafter referred to as “slag”) is generated. As a construction waste, stacking of the slag not only occupies a large amount of land, but also causes serious environmental pollution. Compared with natural aggregates, the slag contains a large number of microcracks and structural defects inside and is prone to expansion by water absorption. Besides, chemical properties of the slag from various sources are also greatly different. Thus, the slag as a substitute material for the natural aggregates has a poorer application effect in concrete (especially the UHPC), which affects mechanical properties and durability of the concrete and is difficult to achieve wide application. Thus, the slag, as a solid waste, has a low regeneration and utilization amount.

### SUMMARY

In view of the deficiencies in the prior art, an objective of the present invention is to provide a slag-based fine aggregate, a supplementary cementitious material and UHPC as well as preparation methods and use thereof. Through a series of modification technologies, including grinding, calcination, nano-repair, and carbon dioxide mineralization treatment, physical and chemical properties of slag are improved, performance stability of a material can be improved, and the slag can replace natural sand or cement for use in preparation of the UHPC.

To achieve the above objective, the present invention adopts the following technical solutions.

In a first aspect, a slag-based fine aggregate is provided, wherein raw materials for preparation include the following components in parts by mass: 100 parts of slag, 0.5-1 part of nano-alumina, and 0.1-0.3 part of carbon dioxide.

In a second aspect, a method for preparing the above slag-based fine aggregate is provided, which includes the following steps:
S11. crushing the slag to a set particle size;
S12. subjecting the crushed slag to carbonization under conditions of a carbon dioxide concentration of 20%-30% and a gas pressure difference of 0.4-0.5 MPa for 2-4 h; and
S13. mixing the carbonized slag with the nano-alumina under stirring to obtain the slag-based fine aggregate.

In a third aspect, slag-based UHPC is provided, which includes the following components in parts by weight: 550-650 parts of cement, 145-175 parts of fly ash, 124-146 parts of silica fume, 200-300 parts of a slag-based supplementary cementitious material, 400-500 parts of the above slag-based fine aggregate, 400-500 parts of natural river sand, 60-100 parts of a fiber, 4-8 parts of a high-range water reducing admixture, and 190-250 parts of water, wherein
raw materials for preparing the slag-based supplementary cementitious material include: a slag and carbon dioxide at a mass ratio of 100:(0.1-0.3); wherein
a source of the slag used for preparing the slag-based supplementary cementitious material is same as that of the slag used for preparing the slag-based fine aggregate.

In a fourth aspect, a method for preparing the above slag-based UHPC is provided, which includes the following steps:
S31. mixing the cement, the fly ash, the silica fume, the slag-based supplementary cementitious material, the slag-based fine aggregate and the natural river sand under stirring to obtain a mixed material;
S32. mixing the water and the high-range water reducing admixture, then adding the same into the mixed material, and conducting stirring to obtain an UHPC slurry;
S33. adding the fiber into the UHPC slurry, conducting stirring, and then conducting pouring and molding; and
S34. subjecting the poured UHPC to curing under conditions of a carbon dioxide concentration of 20%-30% and a gas pressure difference of 0.4-0.5 MPa for 24-48 h.

In a fifth aspect, use of the above slag-based UHPC is provided, wherein the use includes using the slag-based UHPC in the fields of bridge engineering and underground engineering.

Beneficial effects of the present invention are as follows.

1. In the present invention, the slag-based fine aggregate is subjected to carbon dioxide carbonization treatment and nano-repair, larger cracks and pores are filled first during a carbonization process, and meanwhile, the nano-alumina can penetrate into finer crack to provide a higher level of a repair effect and form a dual repair mechanism, thereby effectively repairing microcracks and pores in the slag, improves physical properties of the slag, and decreasing a water absorption rate and expansibility. The treated slag-based fine aggregate can significantly improve the compressive strength and durability of the UHPC, thus having a more outstanding application effect in high-strength engineering.

2. In the present invention, the slag-based supplementary cementitious material is subjected to activation treatment through grinding and calcination technologies, thereby enhancing potential cementitious properties of the slag and making the slag capable of partially replacing traditional cement. A calcined slag-based material is combined with a carbon dioxide carbonization technology, which not only improves mechanical properties of a material, but also significantly improves the compressive strength and durability of the UHPC, thus ensuring long-term use in high-demand structures.

3. In the UHPC of the present invention, through deep treatment of tunnel slag using a comprehensive optimization scheme (including grinding, calcination, nano-repair, and carbon dioxide carbonization treatment, etc.), physical and chemical properties of the slag are enhanced, performance stability of a material is improved, waste slag is successfully converted into a raw material for the UHPC, and dependence on natural aggregates and cement is reduced. During a preparation process, a carbon dioxide curing technology is used in an early stage after concrete pouring. By enabling a reaction of carbon dioxide with calcium hydroxide in concrete to generate calcium carbonate to form a dense microstructure, not only is the early strength of the concrete improved, but also the long-term durability of the concrete is further improved. Not only is the problem of waste stacking alleviated, but also exploitation of natural resources is reduced, a production cost of the UHPC is reduced, and environmental protection and resource conservation are facilitated. Moreover, a carbon dioxide gas emitted from the industry is effectively utilized, thereby improving the strength and durability of a material. Meanwhile, carbon capture is achieved, which can effectively reduce emission of greenhouse gas and is in line with a development trend of green building materials.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 is a physical image of a slag-based fine aggregate in Example 1.

FIG. 2 is a diagram showing characterization results of the slag-based fine aggregate in Example 1.

FIG. 3 is a diagram showing characterization results of a slag-based fine aggregate in Comparative Example 1.

FIG. 4 is a diagram showing characterization results of a slag-based fine aggregate in Comparative Example 2.

FIG. 5 is a diagram showing X-ray diffraction (XRD) test results of slag-based supplementary cementitious materials in Example 2 and Comparative Example 3.

FIG. 6 is a flow chart of preparation methods in Example 1, Example 2 and Example 3.

### DETAILED DESCRIPTION

It should be noted that the following detailed description is exemplary and is intended to provide further explanation of the present invention. Unless otherwise specified, all technical terms and scientific terms used herein have the same meanings as commonly understood by those of ordinary skill in the art to which the present invention belongs.

It should be noted that the terms used herein are only for describing specific embodiments and are not intended to limit the exemplary embodiments according to the present invention. As used herein, unless otherwise expressly stated in the context, singular forms are also intended to include plural forms. In addition, it should also be understood that when the terms “include” and/or “comprise” are used in the specification, the terms indicate existence of features, steps, operations, devices, components, and/or combinations thereof.

A slag-based fine aggregate is provided, wherein raw materials for preparation include the following components in parts by mass: 100 parts of slag, 0.5-1 part of nano-alumina, and 0.1-0.3 part of carbon dioxide.

Optionally, the nano-alumina has a particle size of 10-100 nm.

A method for preparing the above slag-based fine aggregate includes the following steps:
S11: crushing the slag to a set particle size;
S12: subjecting the crushed slag to carbonization under conditions of a carbon dioxide concentration of 20%-30% and a gas pressure difference of 0.4-0.5 MPa for 2-4 h; and
S13: mixing the carbonized slag with the nano-alumina under stirring to obtain the slag-based fine aggregate.

Optionally, in the S11, the slag is crushed to the particle size of 0.1-5 mm.

Optionally, in the S11, the crushed slag is cleaned and then air-dried to surface dryness.

Optionally, in the S12, 0.1-0.3 part of the carbon dioxide is added in the form of a mixed gas at the set concentration and gas pressure difference, and an addition amount of the carbon dioxide is not less than a carbonization reaction amount of the crushed slag. The carbonization is conducted in an environment with humidity of 40%-70% and a temperature of 30° C.-40° C., and water required for a carbonization process is provided by the environment with the humidity.

Optionally, in the S13, after the nano-alumina is mixed with the slag-based fine aggregate, a nano-material is filled into microcracks of slag particles through mechanical stirring, where a gas at a pressure of 0.1-0.5 MPa is introduced at a speed of 5-10 m/s to achieve airflow-assisted filling of the nano-alumina in a stirrer, so that the nano-alumina better penetrates into the microcracks of the slag-based fine aggregate.

Optionally, in the S12, after the carbonization is completed, cooling is conducted to room temperature in a dry and ventilated environment.

Optionally, in the S13, a stirring speed is 60-80 r/min, and a stirring time is 30-40 min.

A slag-based UHPC, including the following components in parts by weight: 550-650 parts of cement, 145-175 parts of fly ash, 124-146 parts of silica fume, 200-300 parts of a slag-based supplementary cementitious material, 400-500 parts of the above slag-based fine aggregate, 400-500 parts of natural river sand, 60-100 parts of a fiber, 4-8 parts of a high-range water reducing admixture, and 190-250 parts of water, where slag of the above slag-based supplementary cementitious material and the slag of the above slag-based fine aggregate have a same source; and raw materials for preparing the slag-based supplementary cementitious material include: the slag and carbon dioxide at a mass ratio of 100:(0.1-0.3).

Optionally, the cement, the fly ash, the silica fume and the natural river sand all satisfy technical specifications for preparation and application of UHPC.

Optionally, the fiber is a steel fiber with a length of 13 mm and a width of 0.2 mm.

Optionally, the high-range water reducing admixture is a polycarboxylate high performance water reducing admixture with a water reducing rate of 30% or above.

A method for preparing the above slag-based UHPC includes the following steps:
S31: mixing the cement, the fly ash, the silica fume, the slag-based supplementary cementitious material, the slag-based fine aggregate and the natural river sand under stirring to obtain a mixed material;
S32: mixing the water and the high-range water reducing admixture, then adding the same into the mixed material, and conducting stirring to obtain an UHPC slurry;
S33: adding the fiber into the UHPC slurry, conducting stirring, and then conducting pouring and molding; and
S34: subjecting the poured UHPC to carbon dioxide curing under conditions of a carbon dioxide concentration of 20%-30% and a gas pressure difference of 0.4-0.5 MPa for 24-48 h.

Optionally, in the S31, a stirring time is 1-2 min; in the S32, a stirring time is 3-5 min; and in the S33, a stirring time is 2-3 min.

Optionally, in the S34, the carbon dioxide curing is conducted after the pouring for 1 day and demolding, and then standard curing is conducted continuously for 7-14 days.

In the method for preparing the above slag-based UHPC, a method for preparing the slag-based supplementary cementitious material includes the following steps:
S21: grinding the slag to a set particle size;
S22: subjecting the ground slag to calcination at 1,150° C.-1,250° C. for 2-2.5 h to obtain a slag clinker; and
S23: subjecting the calcined slag clinker to carbonization under conditions of a carbon dioxide concentration of 20%-30% and a gas pressure difference of 0.4-0.5 MPa for 2-4 h to obtain the slag-based supplementary cementitious material.

Optionally, in the S21, the slag is crushed and then ground to the particle size of 1-75 μm.

Optionally, in the S23, a carbonization temperature is 30° C.-40° C.

Optionally, in the S23, after the carbonization is completed, cooling is conducted to room temperature in a dry and ventilated environment.

A method of using the above slag-based UHPC is provided, wherein the method includes: using the slag-based UHPC in the fields of bridge engineering and underground engineering.

The Slag used in the following various examples and comparative examples is derived from waste slag excavated during urban tunnel construction, which has main chemical components of silica and aluminum oxide and has similar chemical composition and components to fine aggregates commonly used in UHPC.

### Example 1

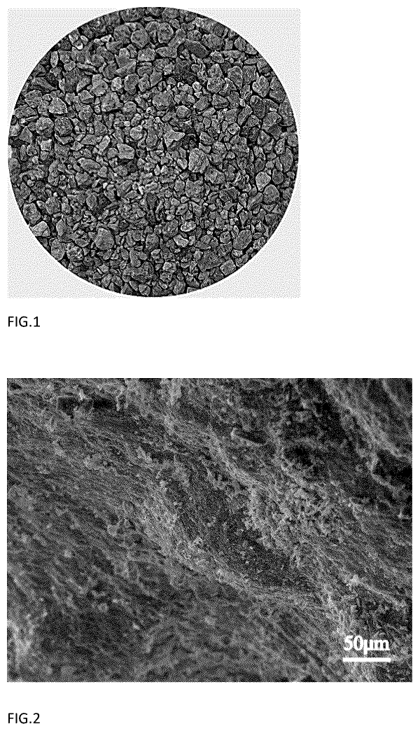

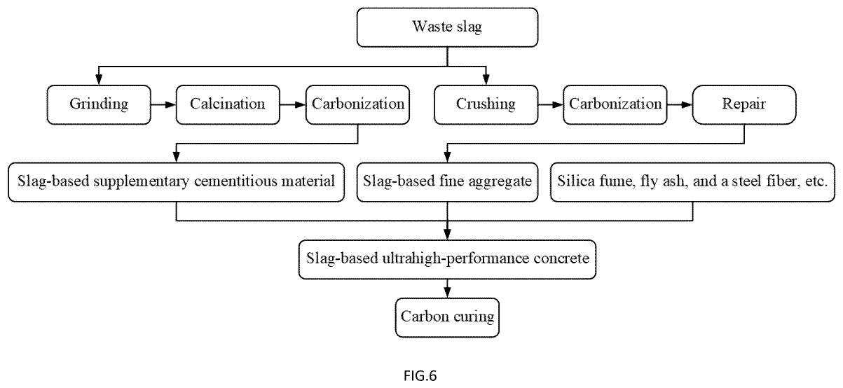

A slag-based fine aggregate is provided, and a preparation method, as shown in FIG. 6, includes:
S11: cleaning slag with clear water to remove a surface impurity, conducting air-drying, crushing the slag with a jaw crusher to a particle size of less than 5 mm, and sieving the crushed slag to obtain particles with a particle size of 1-5 mm to meet particle size requirements of UHPC for a fine aggregate;
S12: placing the slag-based fine particles in a closed reaction chamber filled with an industrial carbon dioxide gas to carry out a carbonization reaction, where the gas in the closed reaction chamber was prepared from a carbon dioxide gas with a purity of greater than 99%, a carbon dioxide volume concentration was 25% (the remaining gas was air), a gas pressure difference between the inside and outside of the closed reaction chamber was 0.5 MPa, a temperature was 35±2° C., and a carbonization reaction time was 4 h; and after the carbonization was completed, taking out a material from the reaction chamber, placing the material in a dry and ventilated environment, and conducting cooling to room temperature; and
S13: adding the carbonized slag-based fine particles into a stirrer, adding 1 wt % (part by mass) of nano-alumina with a particle size of 70 nm according to a proportion, and conducting dry mixing at a stirring speed of 60 r/min for 40 min to prepare the slag-based fine aggregate as shown in FIG. 1, where a gas at a pressure of 0.5 MPa was introduced into the stirrer at a speed of 5 m/s to achieve airflow assisted filling of the nano-alumina, so as to enable the nano-alumina to better penetrate into microcracks of the slag-based fine aggregate.

Due to a tunnel construction process, a large number of microcracks and structural defects exist in the slag. A calcium carbonate component is generated during a carbonization process in the S12, which first fills larger cracks and pores. Meanwhile, the nano-alumina used in the S13 can achieve a mechanical filling effect on finer cracks, including microcracks on a surface of the fine aggregate and small cracks remaining from large cracks after the carbonization process, thereby providing a higher level of a repair effect and forming a dual repair mechanism. Microscopic characterization results are shown in FIG. 2, indicating that the microcracks and pores in the slag can be effectively repaired, and a water absorption rate and expansibility are decreased. According to measurement, the water absorption rate is 2%-4%, and the expansibility is non-expansive or is decreased by 50% compared with an expansion rate of slag without any treatment.

### Comparative Example 1

A slag-based fine aggregate is provided, and a preparation method is different from that in Example 1 as follows: only the steps S11 and S12 were used, and the step S13 was not used.

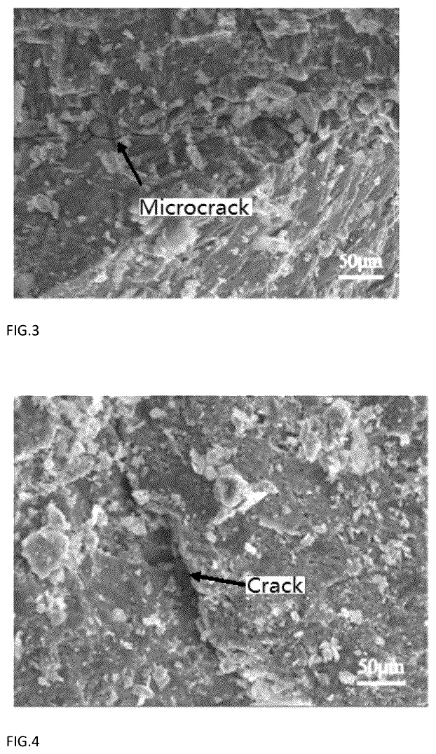

Microscopic characterization results are shown in FIG. 3. It can be seen that under a same magnification as Example 1, microcracks still exist after only carbon dioxide carbonization, indicating that repair of fine cracks is limited.

### Comparative Example 2

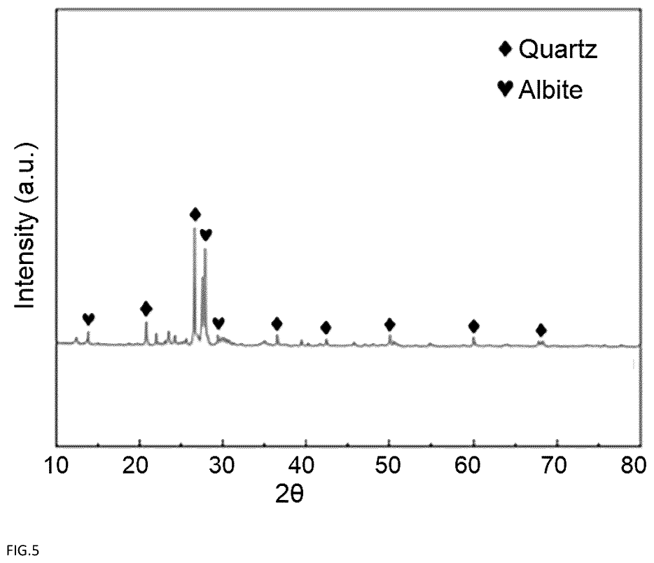

A slag-based fine aggregate is provided, and a preparation method is different from that in Example 1 as follows: only the steps S11 and S13 were used, and the step S12 was not used. Microscopic characterization results are shown in FIG. 4. It can be seen that, under a same magnification as Example 1, larger cracks still exist after only nano-repair, indicating that repair of larger cracks is limited.

### Example 2

A slag-based supplementary cementitious material is provided, and a preparation method, as shown in FIG. 6, includes:
S21: cleaning slag with clear water to remove a surface impurity, conducting air-drying, crushing and grinding the slag with a ball mill to a particle size of less than 75 μm, and sieving the crushed and ground slag to obtain a powder with a particle size of 1-75 μm;
S22: subjecting the sieved powder to calcination at a temperature of 1,200° C. for a time of 2.5 h, and then, conducting cooling in an environment at room temperature to obtain a slag-based cementitious material clinker; and
S23: placing the slag-based cementitious material clinker in a closed reaction chamber filled with an industrial carbon dioxide gas to carry out a carbonization reaction, where the gas in the closed reaction chamber was prepared from a carbon dioxide gas with a purity of greater than 99%, a carbon dioxide volume concentration was 25%, a gas pressure difference in the closed reaction chamber was 0.5 MPa, a temperature was 35±2° C., and a carbonization reaction time was 4 h; and after the carbonization was completed, taking out a material from the reaction chamber, placing the material in a dry and ventilated environment, and conducting cooling to room temperature to obtain the slag-based supplementary cementitious material.

The obtained slag-based supplementary cementitious material was subjected to detection by XRD. Results are shown in FIG. 5, indicating that main components include quartz and albite.

### Example 3

A slag-based UHPC, including the following components in parts by weight: 560 parts of cement, 160 parts of fly ash, 132 parts of silica fume, 240 parts of the slag-based supplementary cementitious material in Example 2, 450 parts of the slag-based fine aggregate in Example 1, 450 parts of natural river sand, 78.5 parts of a fiber, 6 parts of a high-range water reducing admixture, and 210 parts of water.

Wherein, the cement, the fly ash, the silica fume and the natural river sand satisfy technical specifications for preparation and application of UHPC. Specifically, the cement is ordinary Portland cement of grade 52.5 or 52.5R; the fly ash is grade I, with a loss on ignition of less than 3.0% and a specific surface area of greater than 1,000 cm²/g; the silica fume has a silica mass percentage of not less than 97%, a pozzolanic activity index of greater than 95%, a specific surface area of greater than 21.0 m²/g, and a density of 2.20 g/cm³; and the natural river sand has a particle size of less than 5 mm and a bulk density of less than 1,200 kg/m³.

The fiber is a steel fiber with a length of 13 mm and a width of 0.2 mm, and has a tensile strength of 2,500 MPa.

The high-range water reducing admixture is a polycarboxylate high performance water reducing admixture with a solid content of greater than 20%, a pH value of about 7.5, and a water reducing rate of 30% or above.

A preparation method, as shown in FIG. 6, includes the following steps:
S31: adding the cement, the fly ash, the silica fume, the slag-based supplementary cementitious material, the slag-based fine aggregate and the natural river sand into a stirrer and conducting even mixing under stirring for 2 min to obtain a mixed material;
S32: mixing the water and the high-range water reducing admixture, then adding the same into the stirrer, and conducting stirring rapidly for 5 min to obtain an UHPC slurry;
S33: sprinkling the steel fiber into the stirrer to prevent condensation and agglomeration during a continuous stirring process, conducting stirring continuously for 3 min to obtain a slag-based UHPC slurry material, and conducting pouring and molding; and
S34: subjecting the poured UHPC to demolding after 1 day, transferring the same into a standard curing chamber, injecting a carbon dioxide-containing gas with a volume concentration of 30% (prepared from carbon dioxide with a concentration of greater than 99%) into the curing chamber to enable a gas pressure inside the curing chamber to be 0.5 MPa higher than that outside the curing chamber, conducting curing for 48 h, then gradually releasing the carbon dioxide gas, and conducting curing continuously in the standard curing chamber for 10 days to obtain the slag-based UHPC.

### Comparative Example 3

An UHPC containing a slag-based fine aggregate includes the following components in parts by weight: 800 parts of cement, 160 parts of fly ash, 132 parts of silica fume, 450 parts of the slag-based fine aggregate in Example 1, 450 parts of natural river sand, 78.5 parts of a fiber, 6 parts of a high-range water reducing admixture, and 210 parts of water.

Preparation and curing methods are similar to those in Example 3, but are different from those in Example 3 as follows: the slag-based supplementary cementitious material in Example 3 was replaced with an equal mass fraction of the cement.

### Comparative Example 4

An UHPC containing a slag-based fine aggregate includes the following components in parts by weight: 560 parts of cement, 160 parts of fly ash, 132 parts of silica fume, the slag-based supplementary cementitious material subjected only to the step S21 in Example 2, 450 parts of the slag-based fine aggregate in Example 1, 450 parts of natural river sand, 78.5 parts of a fiber, 6 parts of a high-range water reducing admixture, and 210 parts of water.

Preparation and curing methods are similar to those in Example 3, but are different from those in Example 3 as follows: the slag-based supplementary cementitious material in Example 3 was replaced with an equal mass fraction of the slag-based supplementary cementitious material subjected only to the step S21 in Example 2.

### Comparative Example 5

An UHPC containing a slag-based supplementary cementitious material includes the following components in parts by weight: 560 parts of cement, 160 parts of fly ash, 132 parts of silica fume, 240 parts of the slag-based supplementary cementitious material in Example 2, 900 parts of natural river sand, 78.5 parts of a fiber, 6 parts of a high-range water reducing admixture, and 210 parts of water.

Preparation and curing methods are similar to those in Example 3, but are different from those in Example 3 as follows: the slag-based fine aggregate in Example 3 was replaced with an equal mass fraction of the natural river sand.

### Comparative Example 6

An UHPC includes the following components in parts by weight: 800 parts of cement, 160 parts of fly ash, 132 parts of silica fume, 900 parts of natural river sand, 78.5 parts of a fiber, 6 parts of a high-range water reducing admixture, and 210 parts of water.

Preparation and curing methods are similar to those in Example 3, but are different from those in Example 3 as follows: the slag-based supplementary cementitious material in Example 3 was replaced with an equal mass fraction of the cement, and the slag-based fine aggregate was replaced with an equal mass fraction of the natural river sand.

### Comparative Example 7

A slag-based UHPC using a slag-based supplementary cementitious material and a slag-based fine aggregate is provided, and raw materials for preparation are the same as those in Example 3.

A preparation method includes the steps S31, S32 and S33 in Example 3, and is different from that in Example 3 as follows: in a step S34, demolding was conducted after 1 day, and a material was transferred into a standard curing chamber and cured for 12 days, i.e., the carbon dioxide curing was not used.

### Test Example

After the curing was completed in Example 3 and Comparative Examples 2, 3, 4 and 5, surface crack areas of specimens were summed and divided by a total surface area of the specimens to obtain total cracking areas per unit area. Results are shown in Table 1.

The materials obtained in Example 3 and Comparative Examples 2, 3, 4 and 5 were detected with detection contents of flowability, compressive strength, 7-d autogenous shrinkage, resistance to chloride-ion-penetration, and impermeability grade. Results are shown in Table 1.

Detection results are shown in FIG. 1.

TABLE 1
Performance detection results of UHPC

| | | | | | Total | | | |
|---|---|---|---|---|---|---|---|---|
| | | Compressive | | | cracking | 7-d | Average | |
| | Flow | strength/(Mpa) | | | area per | shrinkage | charge | |
| | value\ | 3-day | 7-day | 28-day | unit area/ | value/ | passed/ | Impermeability |
| | (mm) | age | age | age | (mm²/m²) | (μm) | (C) | grade |
| Example 3 | 240 | 85.4 | 104.8 | 132.6 | 116.7 | 578 | 21 | >12 |
| Comparative | 245 | 80.3 | 99.2 | 124.8 | 138.8 | 627 | 35 | >10 |
| Example 3 | | | | | | | | |
| Comparative | 240 | 76.4 | 90.1 | 118.7 | 118.8 | 588 | 25 | >12 |
| Example 4 | | | | | | | | |
| Comparative | 250 | 78.2 | 98.6 | 123.2 | 135.2 | 645 | 37 | >10 |
| Example 5 | | | | | | | | |
| Comparative | 260 | 75.1 | 89.6 | 116.7 | 256.8 | 730 | 64 | >10 |
| Example 6 | | | | | | | | |
| Comparative | 240 | 69.6 | 85.4 | 130.9 | 119.6 | 586 | 26 | >12 |
| Example 7 | | | | | | | | |

As can be seen from Table 1, the UHPCs in Example 3 and comparative examples exhibit significant differences in multiple performance indicators, and especially have particularly prominent performance in terms of compressive strength and crack control. The compressive strength in Example 3 in 3-day age, 7-day age and 28-day age respectively reaches 85.4 MPa, 104.8 MPa and 132.6 MPa, which are all higher than those in Comparative Examples 3-6. Moreover, in the 3-day age and the 28-day age, a difference value between Example 3 and Comparative Example 6 is higher than a sum of difference values between Comparative Examples 4 and 5 and Comparative Example 6, indicating that the slag-based supplementary cementitious material and the slag-based fine aggregate have a synergistic effect, and an enhancement effect of comprehensive addition is superior to a sum of enhancement effects of separate addition of the two. After the slag is subjected to multiple treatments, activity of the slag-based supplementary cementitious material is increased, microcracks of the slag-based fine aggregate are repaired, and strength and compactness of concrete are comprehensively improved, thereby effectively improving mechanical properties of the concrete. Meanwhile, early strength of the concrete is significantly enhanced under carbon dioxide curing conditions, and strengths in the 3-day age and the 7-day age in Example 3 are both increased by 23% compared with those in Comparative Example 7. In addition, a total cracking area per unit area in Example 3 is 116.7 mm²/m², and an autogenous shrinkage value is 578 μm, which are obviously lower than those in Comparative Examples 3-7, indicating that the slag-based concrete has better performance in reducing crack generation and early autogenous shrinkage. This is mainly due to two reasons. The slag-based supplementary cementitious material replaces a part of cement, thereby reducing hydration heat and controlling cracking caused by autogenous shrinkage and thermal stress in the UHPC. The slag-based fine aggregate, due to an irregular surface shape, enhances a mechanical interlocking force between a concrete matrix and an aggregate, thereby improving an ability of the fine aggregate to restrain shrinkage of cement slurry. Meanwhile, after treatment with a nano-repair material and carbon dioxide, volume stability of a material is also ensured.

In terms of resistance to chloride-ion-penetration, the average charge passed in Example 3 is only 21 C, which is obviously lower than that in Comparative Examples 3-7, meets performance requirements of UHPC and exhibits better impermeability. It is indicated that after permeation of a treated slag material, the concrete has a denser internal structure and a decreased porosity, thereby significantly improving impermeability.

In addition, the impermeability grades in Comparative Example 3, Comparative Example 5 and Comparative Example 6 are all >10, indicating that separate addition of the slag-based fine aggregate or the slag-based supplementary cementitious material cannot effectively improve the impermeability grade. Meanwhile, the impermeability grade in Example 3 is >12, further indicating that simultaneous addition of the slag-based fine aggregate and the slag-based supplementary cementitious material has a synergistic effect, demonstrating advantages of the present invention in terms of water resistance and durability.

The slag-based fine aggregate and the slag-based supplementary cementitious material have similar chemical composition, meaning that the two have better compatibility in concrete. Since the two are both derived from slag, an interface bonding force between the two is higher, and the fine aggregate can better bond to the cementitious material to form a dense interfacial transition zone (ITZ). Compactness of the interfacial transition zone is crucial to overall mechanical properties, crack resistance, durability and the like of the UHPC.

The foregoing is merely illustrative of preferred examples of the present invention and is not intended to limit the present invention. For those skilled in the art, the present invention may have various modifications and alterations. Any modifications, equivalent substitutions, improvements, etc., made within the spirit and principles of the present invention shall be included within the scope of protection of the present invention.

1. A slag-based fine aggregate, wherein raw materials for preparation comprise the following components in parts by mass: 100 parts of slag, 0.5-1 part of nano-alumina, and 0.1-0.3 part of carbon dioxide;
a method for preparing the slag-based fine aggregate comprises the following steps:
S11: crushing the slag to a set particle size;
S12: subjecting the crushed slag to carbonization under conditions of a carbon dioxide concentration of 20%-30% and a gas pressure difference of 0.4-0.5 MPa for 2-4 h; and
S13: mixing the carbonized slag with the nano-alumina under stirring to obtain the slag-based fine aggregate;
wherein in the S11, the slag is crushed to the particle size of 0.1-5 mm;
in the S12, the carbonization is conducted in an environment with a humidity of 40%-70% and a temperature of 30° C.-40° C.; and
in the S13, a gas at a pressure of 0.1-0.5 MPa is introduced at a speed of 5-10 m/s to achieve airflow assisted filling of the nano-alumina.

2. The slag-based fine aggregate according to claim 1, wherein the nano-alumina has a particle size of 10-100 nm.

3. A method for preparing the slag-based fine aggregate according to claim 2, comprising the following steps:
S11: crushing the slag to a set particle size;
S12: subjecting the crushed slag to carbonization under conditions of a carbon dioxide concentration of 20%-30% and a gas pressure difference of 0.4-0.5 MPa for 2-4 h; and
S13: mixing the carbonized slag with the nano-alumina under stirring to obtain the slag-based fine aggregate.

4. The method for preparing the slag-based fine aggregate according to claim 3, wherein in the S12, the carbonization is conducted in an environment with a humidity of 40%-70% and a temperature of 30° C.-40° C.

5. A Slag-based ultrahigh-performance concrete (UHPC), comprising the following components in parts by weight: 550-650 parts of cement, 145-175 parts of fly ash, 124-146 parts of silica fume, 200-300 parts of a slag-based supplementary cementitious material, 400-500 parts of the slag-based fine aggregate according to claim 1, 400-500 parts of natural river sand, 60-100 parts of a fiber, 4-8 parts of a high-range water reducing admixture, and 190-250 parts of water;
raw materials for preparing the slag-based supplementary cementitious material comprise: a slag and carbon dioxide at a mass ratio of 100:(0.1-0.3); wherein,
a source of the slag used for preparing the slag-based supplementary cementitious material is same as that of a slag used for preparing a slag-based fine aggregate; and
a method for preparing the slag-based supplementary cementitious material comprises the following steps:
S21: grinding the slag to a set particle size;
S22: subjecting the ground slag to calcination at 1,150° C.-1,250° C. for 2-2.5 h to obtain a slag clinker; and
S23: subjecting the calcined slag clinker to carbonization under conditions of a carbon dioxide concentration of 20%-30% and a gas pressure difference of 0.4-0.5 MPa for 2-4 h to obtain the slag-based supplementary cementitious material;
wherein in the S21, the slag is crushed and then ground to the particle size of 1-75 μm.

6. A method for preparing the slag-based UHPC according to claim 5, comprising the following steps:
S31: mixing the cement, the fly ash, the silica fume, the slag-based supplementary cementitious material, the slag-based fine aggregate and the natural river sand under stirring to obtain a mixed material;
S32: mixing the water and the high-range water reducing admixture, then adding the same into the mixed material, and conducting stirring to obtain UHPC slurry;
S33: adding the fiber into the UHPC slurry, conducting stirring, and then conducting pouring and molding; and
S34: subjecting the poured UHPC to carbon dioxide curing under conditions of a carbon dioxide concentration of 20%-30% and a gas pressure difference of 0.4-0.5 MPa for 24-48 h.

7. The slag-based UHPC according to claim 5, wherein:
in the S23, a carbonization temperature is 30° C.-40° C.; and
in the S23, after the carbonization is completed, cooling is conducted to room temperature in a dry and ventilated environment.
